(19) United States
(12) Patent Application Publication
(10) Pub. No.: US 2026/0129379 A1
(43) Pub. Date: May 7, 2026

(54) HEARING ASSISTANCE DEVICES

(71) Applicant: SHENZHEN SHOKZ CO., LTD., Shenzhen (CN)

(72) Inventors: Xiaopeng YU, Shenzhen (CN); Huifang TANG, Shenzhen (CN); Chaowu LI, Shenzhen (CN)

(73) Assignee: SHENZHEN SHOKZ CO., LTD., Shenzhen (CN)

(21) Appl. No.: 19/435,708

(22) Filed: Dec. 29, 2025

Related U.S. Application Data
(63) Continuation of application No. PCT/CN2024/111547, filed on Aug. 12, 2024.

(51) Int. Cl. H04R 25/00; H04R 1/08; H04R 1/10

(52) U.S. Cl. CPC H04R 25/65; H04R 1/086; H04R 1/1041; H04R 1/105; H04R 25/609; H04R 2225/61

(57) ABSTRACT

The present disclosure relates to a microphone, a processor, a speaker, and a support member. The microphone is disposed in the support member, an outer surface of the support member is provided with a recessed portion, the support member is further provided with a microphone hole, the microphone hole has a first opening and a second opening opposite to each other, the first opening is located in the recessed portion, and the second opening is located on an inner surface of the support member and connected to the microphone, and the recessed portion is configured to prevent the user from touching or blocking the first opening.

### CROSS-REFERENCE TO RELATED APPLICATIONS

This application is a continuation of International Application No. PCT/CN2024/111547, filed on August 12, 2024, the entire contents of which are hereby incorporated by reference.

### TECHNICAL FIELD

The present disclosure generally relates to the field of acoustics, and in particular, to hearing assistance devices.

### BACKGROUND

A hearing assistance device is configured to assist hearing-impaired patients in listening. A microphone, serving as a component for capturing environmental sounds, plays a critical role in the hearing assistance device. The quality of sound reception by the microphone determines auditory experience, safety, and social capabilities of the hearing-impaired patients.

To enhance the sound reception of the microphone, certain gain algorithms are employed within the hearing assistance device to enable the hearing-impaired patients to clearly perceive surrounding sounds. However, the application of gain may induce howling. The howling may not only cause auditory damage and discomfort to the hearing-impaired patients, but may also interfere with normal signals, thereby adversely affecting the social experience of the hearing-impaired patients.

When an elderly user presses a button on a housing of the hearing assistance device, a microphone hole is often obstructed by inadvertently touching. Under such circumstances, the hearing assistance device becomes more susceptible to generating the howling.

### SUMMARY

The present disclosure provides a hearing assistance device, which is used to solve the problem that when a button is touched, a microphone hole is easily obstructed and howling is generated.

In one embodiment, the hearing assistance device is provided, including:

a microphone, configured to receive an initial sound signal and convert the initial sound signal into an electric signal;

a processor, in signal connection with the microphone, wherein the processor is configured to process the electric signal and generate a control signal;

a speaker, in signal connection with the processor, wherein the speaker is configured to convert the control signal into a hearing assistance sound signal; and

a support member, worn on a user’s head, wherein the microphone is disposed in the support member, an outer surface of the support member is provided with a recessed portion, the support member is further provided with a microphone hole, the microphone hole has a first opening and a second opening opposite to each other, the first opening being located in the recessed portion, and the second opening being located on an inner surface of the support member and connected to the microphone, and the recessed portion is configured to prevent the user from touching or blocking the first opening.

In one embodiment, the recessed portion has a bottom wall and a side wall, and the first opening is located on the bottom wall or the side wall of the recessed portion.

In one embodiment, the recessed portion is provided with a partition structure, the partition structure shields the first opening, and a gap is formed between the partition structure and the first opening.

In one embodiment, in a direction perpendicular to the outer surface of the support member having the recessed portion, a projection of the partition structure covers all or part of the first opening.

In one embodiment, the partition structure is a partition plate or a partition mesh.

In one embodiment, an upper surface of the partition structure is flush with the outer surface of the support member having the recessed portion.

In one embodiment, the recessed portion is a strip-shaped groove.

In one embodiment, the first opening is located at a middle portion or an end portion of the strip-shaped groove.

In one embodiment, the recessed portion has a linear configuration, a curved configuration, an X-configuration, or a herringbone configuration.

In one embodiment, the outer surface of the support member is further provided with a button, the outer surface of the support member includes a top surface, a bottom surface, an inner side surface, and an outer side surface, the inner side surface faces the user when the hearing assistance device is worn by the user, and the recessed portion and the button are disposed on the bottom surface.

In one embodiment, a portion of the recessed portion extends to at least one of the outer side surface or the inner side surface.

In one embodiment, a portion of the recessed portion extends to an edge of the bottom surface.

In one embodiment, at least a portion of an opening of the recessed portion faces a first direction, at least another portion of the opening of the recessed portion faces a second direction, and an included angle between the first direction and the second direction is greater than or equal to 60°.

In one embodiment, the outer surface of the support member is provided with a plurality of button bosses, the button is disposed on the button bosses, and a region between two adjacent button bosses forms the recessed portion.

In one embodiment, a distance between the first opening and the outer side surface is less than a distance between the first opening and the inner side surface.

In one embodiment, a width of the recessed portion is within a range of 1 millimeter (mm) to 2 mm, and a depth of the recessed portion is within a range of 0.5 mm to 1.5 mm.

In one embodiment, the width of the recessed portion is within a range of 1.5 mm to 2 mm, and the depth of the recessed portion is within a range of 1 mm to 1.5 mm. Alternatively, the width of the recessed portion is within a range of 1 mm to 1.5 mm, and the depth of the recessed portion is within a range of 0.5 mm to 1 mm.

In one embodiment, a length of the recessed portion is larger than 5 mm.

In one embodiment, a hearing assistance device is provided, including:

a microphone, configured to receive an initial sound signal and convert the initial sound signal into an electric signal;

a processor, in signal connection with the microphone, the processor configured to process the electric signal and generate a control signal;

a speaker, in signal connection with the processor, the speaker configured to convert the control signal into a hearing assistance sound signal; and

a support member, worn on a user’s head, wherein the microphone is disposed in the support member, an outer surface of the support member is provided with a protrusion portion, the support member is further provided with a microphone hole, the microphone hole has a first opening and a second opening opposite to each other, the first opening being located on the outer surface of the support member, and the second opening being located on an inner surface of the support member and connected to the microphone, the protrusion portion is disposed on a side of the first opening, and the protrusion portion is configured to prevent the user from touching or blocking the first opening.

In one embodiment, the protrusion portion is a button boss, and the button boss is provided with a button.

In one embodiment, a height of the protrusion portion is greater than 0.8 mm; and/or a minimum distance between an edge of the first opening and the protrusion portion is less than 0.4 mm.

In one embodiment, the protrusion portion has a linear configuration, a curved configuration, an L-configuration, or a U-configuration.

In one embodiment, a hearing assistance device is provided, including:

a microphone, configured to receive an initial sound signal and convert the initial sound signal into an electric signal;

a processor, in signal connection with the microphone, the processor configured to process the electric signal and generate a control signal;

a speaker, in signal connection with the processor, wherein the speaker is configured to convert the control signal into a hearing assistance sound signal; and

a support member worn on a user’s head, wherein the microphone is disposed in the support member, an outer surface of the support member is provided with a button in signal connection with the processor; the support member is further provided with a microphone hole, the microphone hole has a first opening and a second opening opposite to each other, the first opening being located on the outer surface of the support member, and the second opening being located in the support member and connected to the microphone; and the first opening and the button are located at two ends of a same surface of the support member.

According to the hearing assistance device of the above embodiments, since the outer surface of the support member is provided with the recessed portion, and the first opening of the microphone hole is located in the recessed portion, the microphone hole forms a recessed hidden configuration, and the recessed portion forms the partition structure outward relative to the microphone hole. Therefore, when a user touches and controls the button, the user can only touch an outer edge of the recessed portion and is prevented from contacting the microphone hole in the recessed portion. That is, even if the user inadvertently touches the button, the microphone hole can not be obstructed, thereby avoiding howling caused by obstructing the microphone hole, and improving the user experience.

### BRIEF DESCRIPTION OF THE DRAWINGS

FIG. 1 is a schematic diagram illustrating an exemplary structure of a hearing assistance device according to some embodiments;

FIG. 2 is a block diagram illustrating an exemplary structure of elements of a hearing assistance device according to some embodiments;

FIG. 3 is a schematic diagram illustrating an exemplary structure of an inner side surface of a first mounting portion according to some embodiments;

FIG. 4 is a schematic diagram illustrating an exemplary structure of an outer side surface of a first mounting portion according to some embodiments;

FIG. 5 is a schematic diagram illustrating an exemplary structure of a top surface of a first mounting portion according to some embodiments;

FIG. 6 is a schematic diagram illustrating an exemplary partial cross-sectional view of a first mounting portion according to some embodiments;

FIG. 7 is a schematic diagram illustrating an exemplary structure of a top surface of a first mounting portion according to some embodiments;

FIG. 8 is a schematic diagram illustrating an exemplary structure of a top surface of a first mounting portion according to some embodiments;

FIG. 9 is a schematic diagram illustrating an exemplary structure of a top surface of a first mounting portion according to some embodiments;

FIG. 10 is a schematic diagram illustrating an exemplary partial cross-sectional view of a first mounting portion according to some embodiments;

FIG. 11 is a schematic diagram illustrating an exemplary partial cross-sectional view of a first mounting portion according to some embodiments;

FIG. 12 is a schematic diagram illustrating an exemplary structure of a top surface of a first mounting portion according to some embodiments;

FIG. 13 is a schematic diagram illustrating an exemplary partial cross-sectional view of a first mounting portion according to some embodiments;

FIG. 14 is a schematic diagram illustrating an exemplary partial cross-sectional view of a first mounting portion according to some embodiments;

FIG. 15 is a schematic diagram illustrating an exemplary partial cross-sectional view of a first mounting portion according to some embodiments;

FIG. 16 is a schematic diagram illustrating an exemplary partial cross-sectional view of a first mounting portion according to some embodiments;

FIG. 17 is a schematic diagram illustrating an exemplary structure of a top surface of a first mounting portion according to some embodiments;

Reference signs are as follows:

1 represents a microphone;

2 represents a processor;

3 represents a speaker;

4 represents a support member, 401 represents a rear hook portion, 402 represents an ear hook portion, 403 represents a first mounting portion, 404 represents a second mounting portion, 4a represents a top surface, 4b represents a bottom surface, 4c represents an inner side surface, 4d represents an outer side surface, 41 represents a button, 42 represents a recessed portion, 421 represents a bottom wall, 422 represents a side wall, 423 represents a partition structure, 43 represents a microphone hole, 431 represents a first opening, 432 represents a second opening, 44 represents a protrusion portion, 45 represents a button boss;

A represents a first direction, B represents a second direction, and θ represents an angle between the first direction A and the second direction B.

### DETAILED DESCRIPTION

The present invention is further described in detail below through specific embodiments with reference to the accompanying drawings. Similar element numbers are used for similar elements in different embodiments. In the following embodiments, many details are described to facilitate better understanding of the present application. However, those skilled in the art can readily recognize that some of these features may be omitted under different circumstances or replaced by other elements, materials, or methods. In some cases, certain operations related to the present application are not shown or described in the specification to avoid obscuring the core parts of the present application with excessive description. For those skilled in the art, detailed description of these related operations is not necessary, as they can fully understand the related operations based on the description in the specification and general technical knowledge in the art.

In addition, the features, operations, or characteristics described in the specification may be combined in any appropriate manner to form various embodiments. Meanwhile, the steps or actions in the method description may also be rearranged or adjusted in a manner obvious to those skilled in the art. Therefore, the various sequences in the specification and drawings are only for clearly describing a particular embodiment and do not imply mandatory sequences, unless otherwise specified that a particular sequence must be followed.

The number of elements in the present disclosure, such as “first,” “second,” etc., is only used to distinguish the described objects and does not have any sequential or technical meaning. The terms “connect” and “couple” as used in the present disclosure, unless otherwise specified, include both direct and indirect connection (coupling).

In some embodiments, a hearing assistance device is provided. The hearing assistance device may be a bone-conduction hearing assistance device. The hearing assistance device may also be an air-conduction hearing assistance device.

A position of a microphone hole in the hearing assistance device is redesigned, so that the microphone hole is relatively concealed without obstructing or impairing normal sound reception of the microphone hole. In the hearing assistance device, the microphone hole is disposed in a recessed structure. The recessed structure is a relatively small structure, thereby preventing a user’s finger from entering the recessed structure. Accordingly, when the user (particularly an elderly user) operates a button, even touches the recessed structure, the concealed microphone hole can not be obstructed. In this configuration, the microphone hole can remain in communication with the external atmosphere, thereby preventing howling caused by obstruction of the microphone hole, and improving user experience.

When the microphone hole is obstructed, a sealed cavity is formed at the microphone hole. Variations in a volume of the sealed cavity cause corresponding changes in air pressure inside the sealed cavity, which induce fluctuations in a diaphragm of the microphone and result in howling. In the embodiment, the position of the microphone hole is redesigned to avoid the obstruction of the microphone hole, thereby preventing the howling.

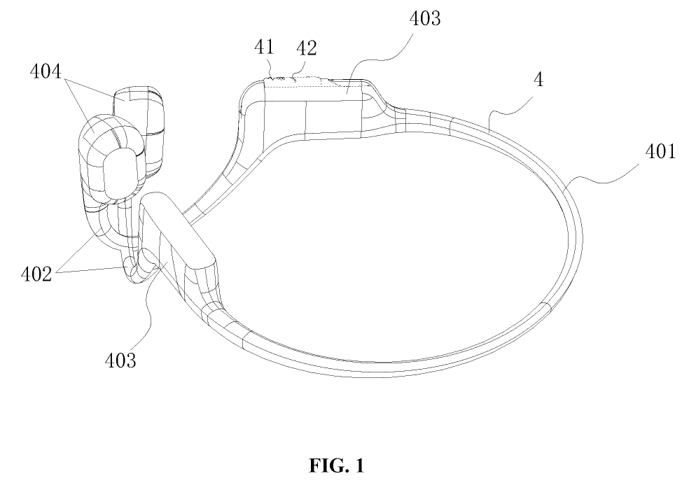

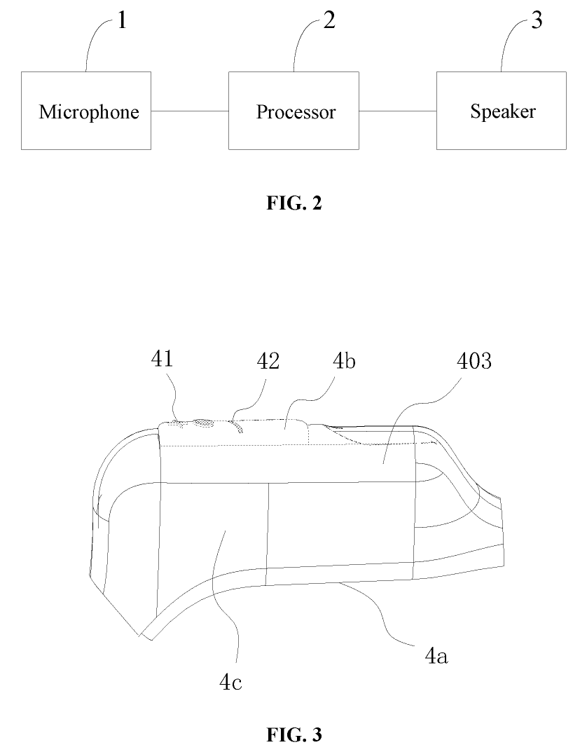

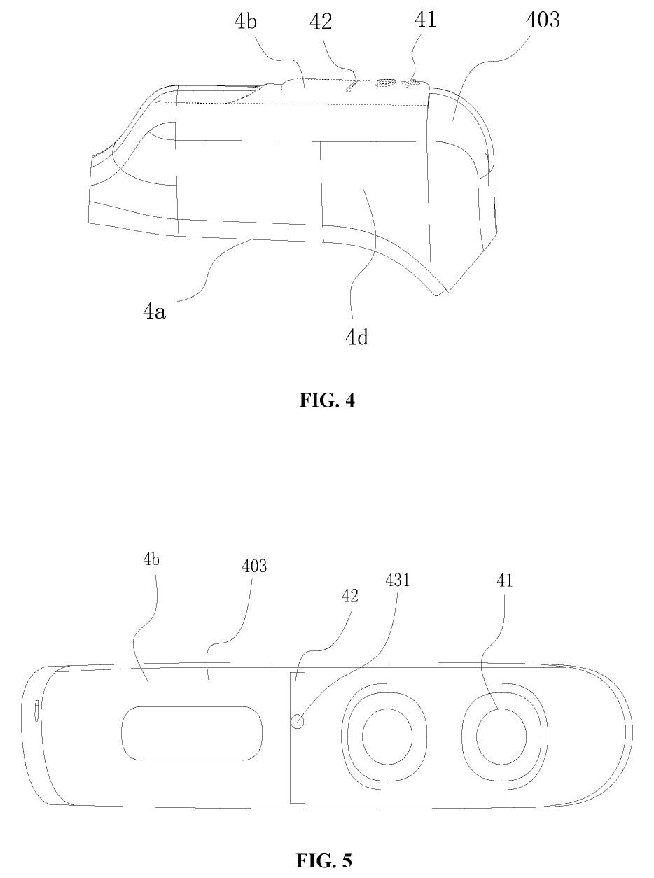

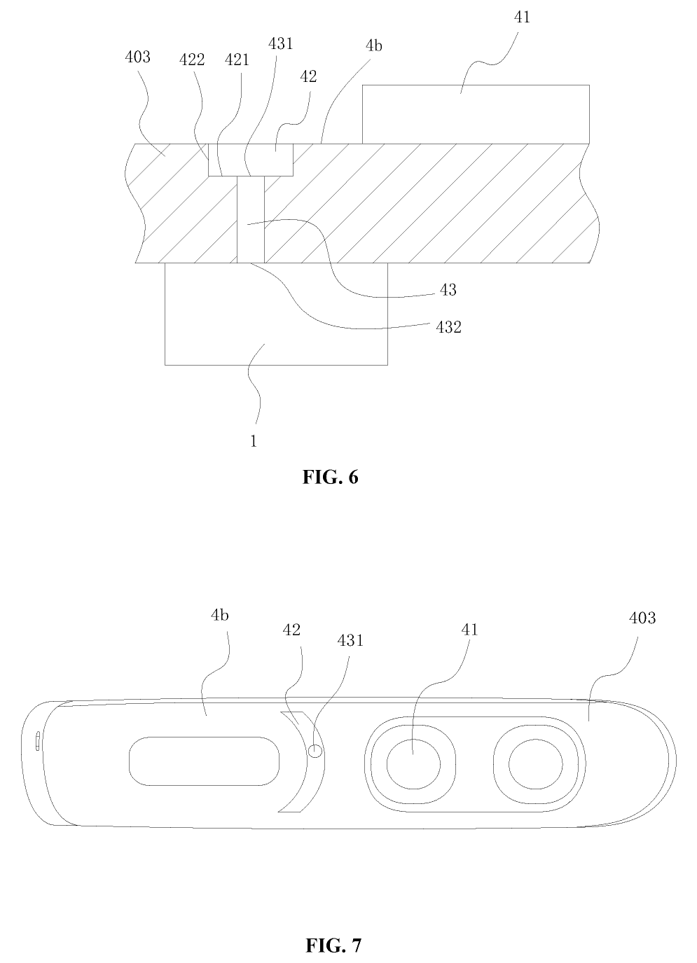

Referring to FIG. 1 to FIG. 6, the hearing assistance device of the embodiment mainly includes a microphone 1, a processor 2, a speaker 3, and a support member 4.

The hearing assistance device may have a rear hook structure. The hearing assistance device may be worn on a user’s head. A portion of the hearing assistance device is located on the user’s ear. The hearing assistance device with the rear hook structure is more stable to wear. Therefore, when the user is walking or exercising, the hearing assistance device can not fall off. The hearing assistance device with the rear hook structure has a one-piece structure with left and right parts connected, so that the hearing assistance device is less likely to be lost.

In other embodiments, the hearing assistance device may have an ear hook structure. The hearing assistance device may be worn on the user’s ear. The hearing assistance device may be designed as a single-ear structure or a dual-ear structure. That is, the user may wear the hearing assistance device on one of the left ear or the right ear, or wear the hearing assistance device on both ears.

In some embodiments, the support member 4 includes a rear hook portion 401, an ear hook portion 402, a first mounting portion 403, and a second mounting portion 404. For example, the support member 4 includes one rear hook portion 401, and two ear hook portions 402, two first mounting portions 403, and two second mounting portions 404. Two ends of the rear hook portion 401 are connected to the two first mounting portions 403, respectively. One of the two first mounting portions 403 is connected to one of the two second mounting portions 404 through one of the two ear hook portions 402. That is, one second mounting portion 404, one ear hook portion 402, one first mounting portion 403, the rear hook portion 401, another first mounting portion 403, another ear hook portion 402, and another second mounting portion 404 are sequentially connected. The ear hook portions 402, the first mounting portions 403, and the second mounting portions 404 connected to the two ends of the rear hook portion 401 may be symmetrically arranged. The rear hook portion 401 is an arc-shaped structure adapted to a human head. The rear hook portion 401 is configured to be worn on the back of the user’s (a hearing-impaired patient’s) head. The ear hook portion 402 is an arc-shaped structure adapted to an outer ear contour. The ear hook portion 402 is configured to be worn on an upper end of the user’s ear. The first mounting portion 403 is configured to be worn on a rear position of the upper end of the user’s ear. The second mounting portion 404 is configured to be worn at an ear canal opening of the user.

Both the first mounting portions 403 and the second mounting portions 404 are provided with accommodation cavities for mounting elements.

The microphone 1 includes a sound receiving device. The microphone 1 is configured to receive an initial sound signal and convert the initial sound signal into an electric signal. The microphone 1 is disposed in the support member 4. The microphone 1 may be disposed in one or two of the two first mounting portions 403 of the support member 4.

The processor 2 is a component for controlling and processing. The processor 2 is in signal connection with the microphone 1. The processor 2 is configured to obtain the electric signal converted by the microphone 1. The processor 2 is configured to process the electric signal and generate a control signal. The processor 2 is disposed in the support member 4. The processor 2 may be disposed in the first mounting portion(s) 403. The processor 2 may also be disposed in the second mounting portion(s) 404, the rear hook portion(s) 401, or the ear hook portion(s) 402.

The speaker 3 is an audio output device. The speaker 3 is in signal connection with the processor 2, and the speaker 3 is configured to convert a control signal into a hearing assistance sound signal and transmit the hearing assistance sound signal to the user. The speaker 3 is disposed in the support member 4. The speaker 3 is disposed in the two second mounting portions 404. A portion of the speaker 3 may be exposed from the second mounting portions 404 for a better playback effect.

The support member 4 may further include elements, such as a battery. The elements, such as the battery, may be disposed in one or more of the rear hook portion 401, the ear hook portions 402, the first mounting portions 403, and the second mounting portions 404. The battery may provide electrical energy for the hearing assistance device.

An outer surface of the support member 4 is further provided with a button 41. The button 41 is disposed on an outer surface of the first mounting portion 403. The button 41 is configured to input the control signal, and the button 41 is in signal connection with the processor 2. The button 41 may include one or more of a volume adjustment button and a start/stop button. For example, the button 41 includes a first button and a second button, the first button is configured to increase a playback volume of the speaker 3, and the second button is configured to decrease the playback volume of the speaker 3. The button 41 protrudes from the outer surface of the first mounting portion 403, so that the user may operate the button 41 by pressing with a finger.

The outer surface of the support member 4 is further provided with a recessed portion 42. The recessed portion 42 is specifically disposed on the outer surface of the first mounting portion 403. The support member 4 is further provided with a microphone hole 43, and the microphone hole 43 is specifically disposed on the first mounting portion 403. The microphone hole 43 is a hole structure with openings at both ends. The microphone hole 43 has a first opening 431 and a second opening 432 opposite to each other, the first opening 431 of the microphone hole 43 is located in the recessed portion 42, and the second opening 432 of the microphone hole 43 is located on an inner surface of the first mounting portion 403. The second opening 432 of the microphone hole 43 is connected to the microphone 1, the microphone 1 is disposed in the first mounting portion 403 and abuts against the inner surface of the first mounting portion 403. The microphone 1 covers the second opening 432 in the first mounting portion 403, so that the microphone hole 1 may be in communication with the external atmosphere through the microphone hole 43.

The first mounting portion 403 may include a top surface 4a, a bottom surface 4b, an inner side surface 4c, and an outer side surface 4d. When the user wears the hearing assistance device, the top surface 4a faces upward, the bottom surface 4b faces downward, the inner side surface 4c faces the user and abuts against the user’s head, and the outer side surface 4d faces away from the user.

In the embodiment, the button 41 is disposed on the bottom surface 4b. Disposing the button 41 on the bottom surface 4b facilitates the user touching and pressing. The button 41 is also less likely to be inadvertently touched by other objects. For example, when the user wears a hat or lies on one’s side, the button 41 may not be inadvertently touched.

The recessed portion 42 is disposed on the bottom surface 4b. That is, the microphone hole 43 is disposed at a lower end position of the first mounting portion 403. The first opening 431 of the microphone hole 43 faces downward when wearing the microphone hole 43, so that foreign objects (e.g., dust) are less likely to enter the microphone hole 43, and rainwater or sweat is also less likely to flow into the microphone hole 43, thereby providing dustproof and waterproof protection.

When the user’s finger presses against the recessed portion 42, the user’s finger is obstructed by the recessed portion 42. The finger is not able to cover and block the first opening 431 of the microphone hole 43. The recessed portion 42 forms a partition protection for the first opening 431, thereby avoiding howling caused by the finger covering and blocking the first opening 431.

In other embodiments, the recessed portion 42 may also be disposed on other surfaces of the first mounting portion 403 except the inner side surface 4c. For example, the recessed portion 42 may be disposed on the top surface 4a or the outer side surface 4d. The microphone hole 43 may be disposed on surfaces of the first mounting portion 403 other than the inner side surface 4c. The recessed portion 42

may also prevent the user from touching and blocking the first opening 431, thereby preventing the howling.

In the embodiment, the recessed portion 42 may be a groove structure whose cross-section is a U-configuration. The recessed portion 42 includes a bottom wall 421 and a side wall 422. The first opening 431 of the microphone hole 43 is disposed on the bottom wall 421 of the recessed portion 42 (e.g., the first opening 431 is disposed at the bottommost portion of the recessed portion 42. When the finger inadvertently touches and presses, the finger can not contact the first opening 431 even if a portion of the finger is squeezed into the recessed portion 42. In other words, disposing the first opening 431 at the bottommost part of the recessed portion 42 provides the best anti-blocking effect.

In other embodiments, the first opening 431 of the microphone hole 43 may also be disposed on the side wall 422 of the recessed portion 42. For example, the first opening 431 may be disposed on the side wall 422 of the recessed portion 42 near the bottom wall 421. When the user inadvertently touches the first opening 431, the first opening 431 also can not be contacted and covered, which can also prevent blocking the first opening 431.

In other embodiments, the recessed portion 42 may be a groove structure whose cross-section is a V-configuration. The recessed portion 42 includes two side walls 422 relatively inclined. The first opening 431 of the microphone hole 43 may also be disposed on the side wall 422 of the recessed portion 42 and the first opening 431 is located on the side wall(s) 422 of the recessed portion 42 near the bottom portion. When the user inadvertently touches the first opening 431, the first opening 431 can not be contacted and covered, which can also prevent blocking the first opening 431.

In the embodiment, the recessed portion 42 is a strip-shaped groove that has a sufficient length. The length of the strip-shaped groove is greater than 5 mm. For example, the length of the recessed portion 42 is 10 mm. When the user’s finger inadvertently touches and presses on the opening of the recessed portion 42, one end or both ends of the recessed portion 42 (i.e., the strip-shaped groove) are not covered by the finger. That is, the user’s finger can not completely block the opening of the recessed portion 42, so that the first opening 431 in the recessed portion 42 can always communicate with the atmosphere, thereby avoiding the howling.

In the embodiment, the recessed portion 42 may be a strip-shaped groove with a linear configuration. A length direction of the strip-shaped groove is parallel to an inner-outer direction of the first mounting portion 403. With such arrangement, the strip-shaped groove more easily extends to an edge position of the bottom surface 4b, a portion of the strip-shaped groove extends to the edge position of the bottom surface 4b, and the edge position of the bottom surface 4b is generally configured as a rounded transition, so that an end portion of the recessed portion 42 extends to the rounded transition at the edge of the bottom surface 4b. It is difficult for the user’s finger to simultaneously press a flat surface and the rounded transition of the bottom surface 4b, and the opening of the recessed portion 42 can not be completely blocked, thereby preventing the first opening 431 from being blocked.

One end of the recessed portion 42 extends to a connecting edge position between the bottom surface 4b and the outer side surface 4d, and the other end of the recessed portion 42 extends to a connecting edge position between the bottom surface 4b and the inner side surface 4c, thereby exposing both ends of the recessed portion 42 to the outside. Alternatively, an end of the recessed portion 42 is located on the bottom surface 4b, and the other end of the recessed portion 42 extends to an edge position on a side of the bottom surface 4b.

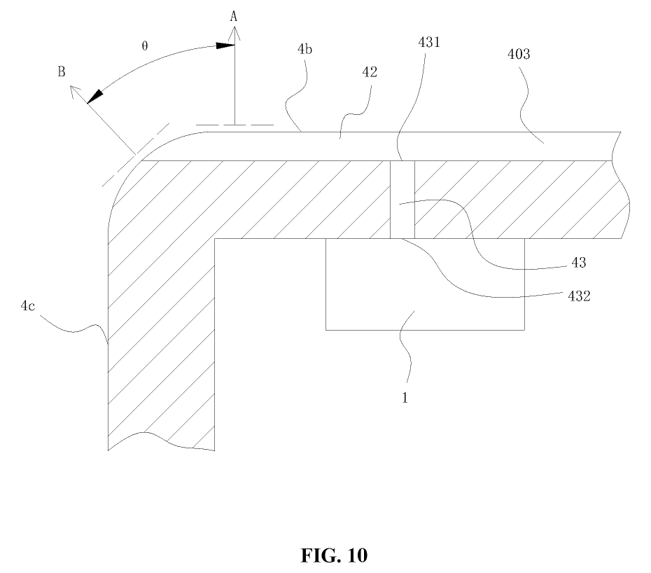

Referring to FIG. 10, the recessed portion 42 is located on different surfaces, and the connecting edge position between the bottom surface 4b and the inner side surface 4c is a curved surface with a rounded transition. A portion of the opening of the recessed portion 42 located on the bottom surface 4b faces a first direction A, and another portion of the recessed portion 42 located on an opening of the curved surface with the rounded transition faces a second direction B. The second direction B refers to a direction in which the opening at the end portion of the recessed portion 42 faces. Referring to FIG. 11, the recessed portion 42 is located on different surfaces, the connecting edge position between the bottom surface 4b and the inner side surface 4c id the curved surface with the rounded transition, a portion of the opening of the recessed portion 42 located on the curved surface with the rounded transition between the bottom surface 4b and the outer side surface 4d faces the first direction A. The first direction A refers to a direction in which the opening at the end portion of the recessed portion 42 faces. Another portion of the opening of the recessed portion 42 located on the curved surface with the rounded transition between the bottom surface 4b and the inner side surface 4c faces the second direction B. The second direction B refers to a direction in which the opening at the other end portion of the recessed portion 42 faces. A planar direction of the opening of the recessed portion 42 is shown by a dashed line in FIG. 10, the first direction A and the second direction B are both normal directions perpendicularly outward from the opening of the recessed portion 42. An included angle θ between the first direction A and the second direction B is greater than or equal to 60°, thereby increasing the length of the recessed portion 42 and a normal angle of the recessed portion 42. When the user’s finger inadvertently touches the recessed portion 42, it is difficult to press and cover the recessed portion 42, which is located on different surfaces and has a certain angular span. This configuration can provide relatively good protection for the first opening 431.

In some embodiments, one end of the recessed portion 42 may also extend to the outer side surface 4d, and/or the other end of the recessed portion 42 may extend to the inner side surface 4c. The end portion of the recessed portion 42 is extended to the outer side surface 4d and/or the inner side surface 4c, thereby increasing the length of the recessed portion 42. The recessed portion 42 is placed on different surfaces to cause the included angle between the normal directions at the two ends of the opening of the recessed portion 42 to be greater than 60°, thereby preventing the user’s finger from simultaneously covering and blocking the entire opening of the recessed portion 42, and also preventing the first opening 431 from being blocked. In some embodiments, referring to FIG. 10, the recessed portion 42 extends to the inner side surface 4c, the user’s finger is less likely to contact the recessed portion 42 located on the inner side surface 4c, thereby providing relatively good protection. Referring to FIG. 11, one end of the recessed portion 42 extends to the outer side surface 4d, and the other end of the recessed portion 42 extends to the inner side surface 4c. The length of the recessed portion 42 is improved, and the recessed portion is simultaneously distributed across three outer surfaces. Therefore, the difficulty that the user simultaneously blocks the opening of the recessed portion 42 is increased, thereby providing the best protection.

In the embodiment, the first opening 431 is disposed at a bottom position of the recessed portion 42, and a maximum distance is formed between the first opening 431 and the opening of the recessed portion 42, so that the difficulty that the user’s finger contacts and covers the first opening 431 is increased.

A position of the first opening 431 along the length direction of the strip-shaped groove may be set according to sound reception requirements of the microphone hole 43. For example, the first opening 431 may be located at a middle portion in the length direction of the strip-shaped groove. That is, the microphone hole 43 is located at the middle portion of the first mounting portion 403, thereby facilitating the installation and layout of the microphone hole 43, and further reducing the probability of inadvertent blocking by the finger.

In other embodiments, the first opening 431 is located in the recessed portion 42, and the first opening 431 is disposed at a position on a symmetrical plane between the outer side surface 4d and the inner side surface 4c that is close to the outer side. A distance between the first opening 431 and the outer side surface 4d is less than a distance between the first opening 431 and the inner side surface 4c. That is, the first opening 431 is disposed relatively outward.

When wearing the hearing assistance device, the inner side surface 4c may vibrate and generate sound waves. The sound waves may not only be directly transmitted to the position of the bottom surface 4b, but can also be transmitted to the user’s head and reflected to the bottom surface 4b. Therefore, the sound waves generated by the inner side surface 4c at the bottom surface 4b are actually a superposition of two sound waves. Accordingly, on the symmetrical plane between the outer side surface 4d and the inner side surface 4c, the sound waves generated by the inner side surface 4c are slightly greater than the sound waves generated by the outer side surface 4d, so that a vibration cancellation plane between the inner side surface 4c and the outer side surface 4d is located at a position on the symmetrical plane between the outer side surface 4d and the inner side surface 4c that is close to the outer side surface 4d. The first opening 431 is disposed at a position on the bottom surface 4b that is close to the outer side relative to the symmetrical plane, so that the dual microphone 3 is located at an actual vibration cancellation plane between the inner side surface 4c and the outer side surface 4d, thereby eliminating vibration interference on the microphone 1.

In some embodiments, the length direction of the strip-shaped groove (the recessed portion 42) having a linear configuration may also be parallel or inclined to a front-rear direction of the first mounting portion 403. A size of the first mounting portion 403 in the front-rear direction is greater than a size of the first mounting portion 403 in the inner-outer direction, thereby increasing the length of the strip-shaped groove. The increased length of the strip-shaped groove also makes it difficult for the user’s finger to completely cover the opening of the recessed portion 42, thereby preventing the first opening 431 from being blocked.

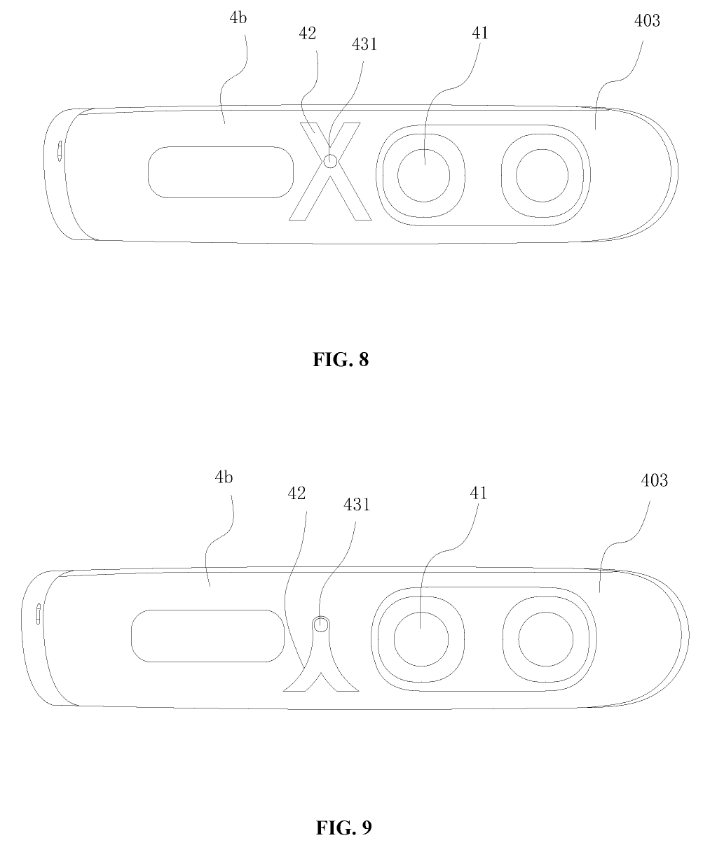

In other embodiments, the recessed portion 42 may also have other shapes. For example, referring to FIG. 7, the recessed portion 42 has a curved configuration. Referring to FIG. 8, the recessed portion 42 has an X-configuration. Referring to FIG. 9, the recessed portion 42 has a herringbone configuration. The recessed portions 42 of other shapes can also increase the length of the recessed portion 42 to make it difficult for the user’s finger to completely cover the opening of the recessed portion 42, thereby preventing the first opening 431 from being blocked.

In the embodiment, to prevent the user’s finger from contacting and blocking the first opening 431 in the recessed portion 42, the recessed portion 42 needs to be set as a structure with a small dimension. The cross-section of the recessed portion 42 with the U-configuration mainly includes two dimensions (a depth and a width). The width and the depth of the recessed portion 42 are interrelated. When the width of the recessed portion 42 is relatively large, the depth of the recessed portion 42 may be also correspondingly set relatively deep. When the recessed portion 42 is relatively wide, sufficient depth must be ensured so that the user’s finger cannot reach the bottom of the recessed portion 42. When the width of the recessed portion 42 is relatively small, the depth of the recessed portion 42 may be correspondingly set relatively shallow. When the recessed portion 42 is relatively narrow, the recessed portion 42 forms a relatively small opening, and the user’s finger can not enter the recessed portion 42. At this time, the user’s finger still can not contact the bottom of the recessed portion 42, even if the depth of the recessed portion 42 is shallow. When the width of the recessed portion 42 is relatively narrow, the depth of the recessed portion 42 may be set relatively shallow, so that the processing difficulty of the recessed portion 42 can be reduced. Certainly, when the width of the recessed portion 42 is relatively narrow, the depth of the recessed portion 42 is set relatively deep, thereby also preventing the user’s finger from blocking the first opening 431 in the recessed portion 42.

In the embodiment, the width of the recessed portion 42 is not greater than 2 mm. For example, the width of the recessed portion 42 is within a range of 1mm to 2 mm. The depth of the recessed portion 42 is not less than 0.5 mm. For example, the depth of the recessed portion 42 is within a range of 0.5mm to 1.5 mm, thereby preventing the finger from extending into the recessed portion 42 and blocking the first opening 431. When the width of the recessed portion 42 is within a range of 1 mm to 1.5 mm, the depth of the recessed portion 42 is within a range of 0.5 mm to 1 mm. By selecting the relatively shallow depth of the recessed portion 42, the sound reception effect of the microphone 1 may be ensured. When the width of the recessed portion 42 is within a range of 1.5 mm to 2 mm, the depth of the recessed portion 42 is within a range of 1 mm to 1.5 mm. By selecting the relatively wide width of the recessed portion 42, it is convenient to install the microphone 1 at the corresponding position. When selecting the width and depth of the recessed portion 42, the corresponding depth and width of the recessed portion 42 need to be adjusted together. For example, when the width of the recessed portion 42 is increased, the depth of the recessed portion needs to be further increased, thereby reducing the probability of the first opening 431 being blocked.

In the embodiment, the outer surface of the support member 4 is provided with the recessed portion 42, and the first opening 431 of the microphone hole 43 is located in the recessed portion 42, the microphone hole 43 forms a recessed hidden arrangement, and the recessed portion 42 forms a partition structure protruding relative to the microphone hole 43. Therefore, when the user touches the control button, the user can only touch the outer edge of the recessed portion 42, and can not contact the microphone hole 43 inside the recessed portion 42. That is, even if the user inadvertently touches the button, the microphone hole 43 can not be blocked, thereby avoiding the howling caused by blocking the microphone hole 43, and thus improving the user experience.

In the embodiment, no other additional partition structure needs to be provided at the opening of the recessed portion 42, so that the sound reception of the first opening 431 of the microphone hole 43 is not blocked, thereby ensuring the sound reception effect of the microphone 1.

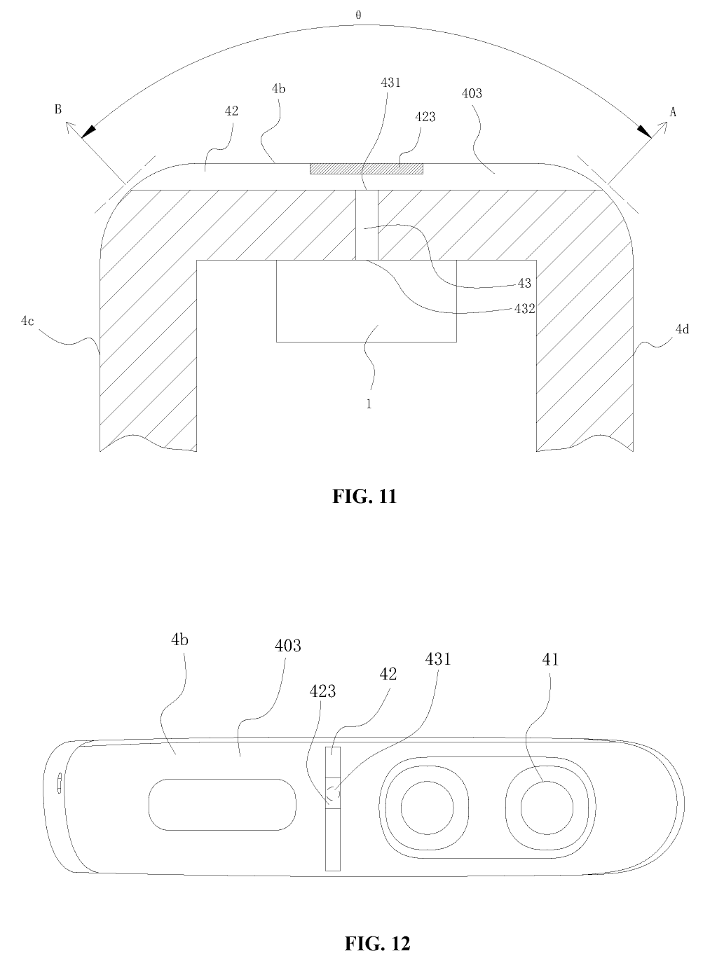

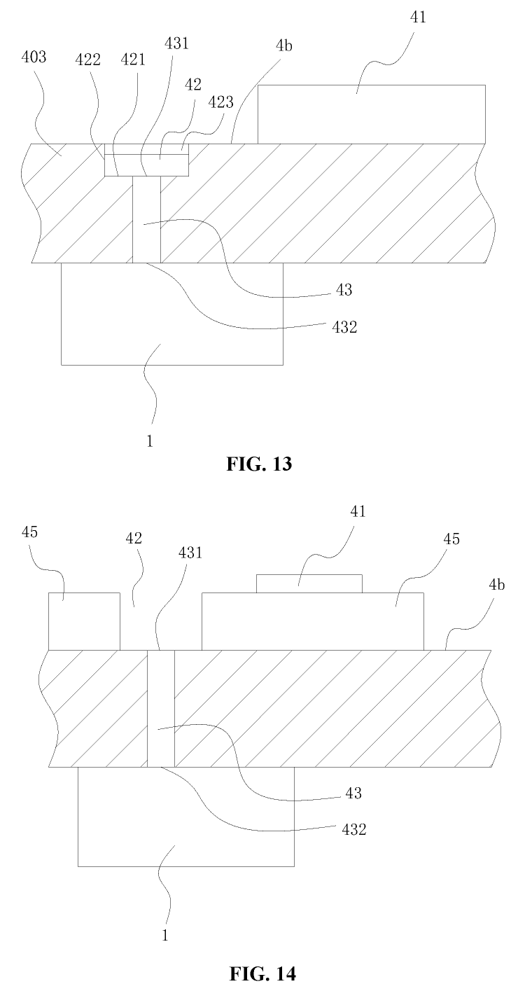

Referring to FIGS. 12 and 13, in one embodiment, a hearing assistance device is provided. A difference between the hearing assistance device and the hearing assistance device in any of the above embodiments is that a partition structure 423 is added.

In some embodiments, the support member 4 is provided with the partition structure 423. The partition structure 423 is located at the opening inside the recessed portion 42 and is located above the first opening 431. The partition structure 423 shields the first opening 431 of the microphone hole 43 and does not contact the first opening 431. The partition structure 423 is spaced apart from the first opening 431, a gap is formed between the partition structure 423 and the first opening 431. The gap can allow the microphone hole 43 to remain in communication with the external atmosphere.

The partition structure 423 provides further protection for the first opening 431 and forms a direct physical partition for the first opening 431, thereby preventing the user’s finger from contacting the first opening 431.

When the support member 4 is provided with the partition structure 423, the recessed portion 42 does not need to be designed narrower or deeper. A relatively wide and shallow recessed portion 42 may be used. For example, the width of the recessed portion 42 may be greater than 2 mm, and the depth may be less than 0.5 mm. On the basis that the physical partition is formed by the partition structure 423, even if the recessed portion 42 is configured relatively wide and shallow, the user’s finger still can not contact the first opening 431 of the microphone hole 43. When the recessed portion 42 is provided with the partition structure 423, the recessed portion 42 is also configured relatively narrow and deep, thereby forming a dual protection effect to prevent the howling.

In the embodiment, the bottom surface 4b of the first mounting portion 403 is a plane. In a direction perpendicular to the plane, a projection of the partition structure 423 covers the entire first opening 431. That is, the first opening 431 is completely hidden below the partition structure 423, thereby preventing the user’s finger from contacting and covering the first opening 431, and providing a good blocking effect. Of course, the bottom surface 4b of the first mounting portion 403 may also be a curved surface. At this time, in a direction directly facing the microphone hole 1, the projection of the partition structure 423 covers the entire first opening 431, thereby providing the blocking effect.

In other embodiments, the projection of the partition structure 423 covers a portion of the first opening 431. That is, a portion of the first opening 431 is hidden below the partition structure 423, and another portion of the first opening 431 is exposed relative to the partition structure 423. The partition structure 423 can still provide the blocking effect, thereby preventing the user’s finger from contacting and covering the first opening 431. Even if the user’s finger contacts the exposed portion of the first opening 431, the user’s finger can not contact the portion of the first opening 431 covered by the partition structure 423. The first opening 431 can not be completely covered and blocked. Therefore, even if the projection of the partition structure 423 covers only a portion of the first opening 431, the blocking effect can still be provided.

In some embodiments, the partition structure 423 may be a partition plate. The partition structure 423 may also be a partition structure, such as a partition mesh, a partition bar, etc. The partition mesh and the partition plate may provide surface blocking with a blocking area. The blocking area may be larger than an area of the first opening 431 to achieve a completely suspended coverage of the first opening 431. A plurality of partition bars may be provided, and the plurality of partition bars may be arranged side by side, thereby providing the same surface blocking effect as the partition plate.

In the embodiment, an upper surface of the partition structure 423 may be flush with the bottom surface 4b of the first mounting portion 403. That is, the partition structure 423 does not protrude from the bottom surface 4b. When the user inadvertently touches the partition structure 423, the user may not feel the presence of the partition structure 423. In other words, the protruding partition structure 423 would give the user a poor experience.

In some embodiments, a portion or all of the partition structure 423 may also protrude from the bottom surface 4b. The upper surface of the partition structure 423 is configured as an arc-shaped structure, such as a spherical surface. No sharp edges are contacted when the user inadvertently touches the partition structure 423, thereby also improving the user experience.

Referring to FIG. 14, in one embodiment, a hearing assistance device is provided. A difference between the hearing assistance device and the hearing assistance device in any of the above embodiments is that a plurality of button bosses 45 are provided, and a region between two adjacent button bosses 45 forms the recessed portion 42.

In some embodiments, the outer surface of the support member 4 is provided with the plurality of button bosses 45. For example, the bottom surface 4b of the first mounting portion 403 is provided with the plurality of button bosses 45, and one or more buttons 41 are provided on one button boss 45. Any two button bosses 45 among the plurality of button bosses 45 are close to each other with a small gap, which forms the recessed portion 42.

The bottom wall 421 of the recessed portion 42 is the bottom surface 4b, and a side wall 422 of the recessed portion 42 is a side surface of the button boss 45. When the first opening 431 is located on the bottom wall 421 of the recessed portion 42, it is equivalent to the first opening 431 being located on the upper surface of the bottom surface 4b. When the first opening 431 is located on the side wall 422 of the recessed portion 42, it is equivalent to the first opening 431 being located on the side surface of the button boss 45.

In the embodiment, by arranging two button bosses 45 close to each other, the recessed portion 42 for blocking the user from contacting the first opening 431 may also be formed. When the user inadvertently touches the two button bosses 45, the user will press on the button bosses 45 and can not contact the first opening 431 between the two button bosses 45, thereby preventing the howling caused by inadvertent touch.

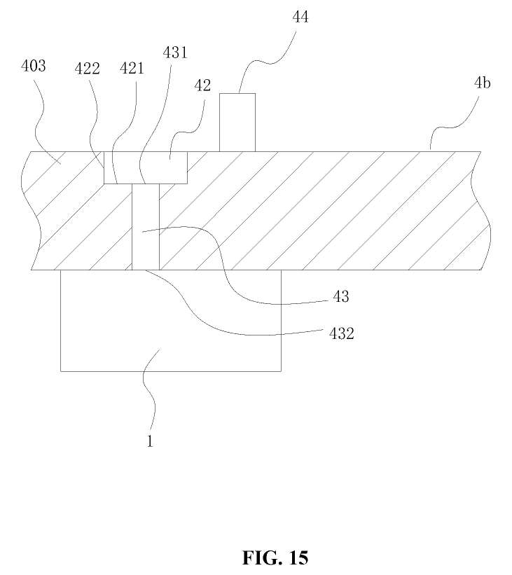

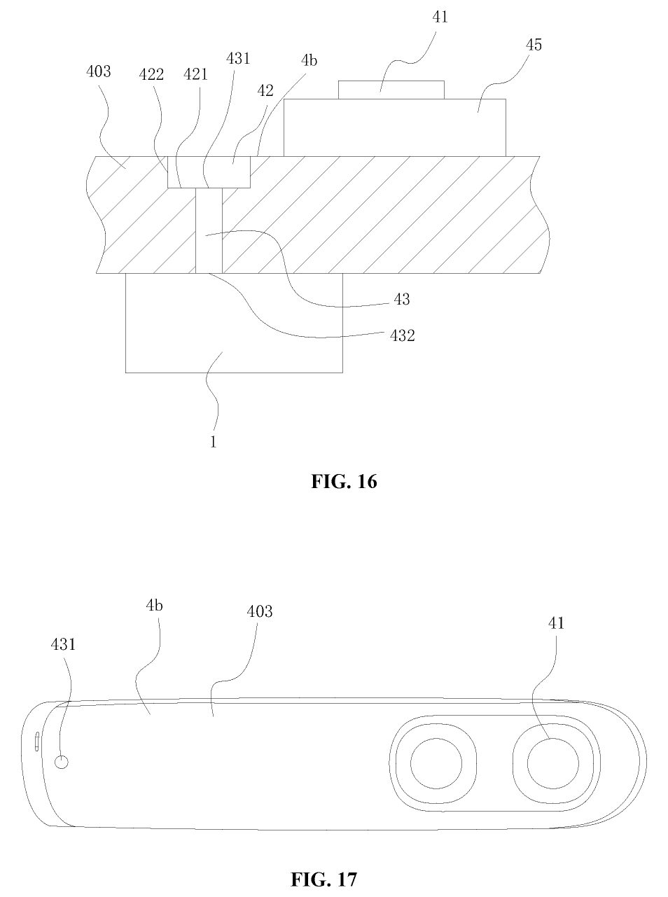

Referring to FIGS. 15 and 16, in one embodiment, a hearing assistance device is provided. A difference between the hearing assistance device and the hearing assistance device in any of the above embodiments is that a protrusion portion 44 is provided instead of the recessed portion 42, and the first opening 431 is located near the protrusion portion 44.

In the embodiment, the first opening 431 may be directly disposed on any outer surface of the support member 4. For example, the first opening 431 is disposed on the bottom surface 4b of the first mounting portion 403, the bottom surface 4b of the first mounting portion 403is further provided with the protrusion portion 44. A small gap is between the protrusion portion 44 and the first opening 431, and the protrusion portion 44 has a certain height, thereby enabling the protrusion portion 44 to block the user from touching and blocking the first opening 431.

The protrusion portion 44 may be a structure integrally formed with the first mounting portion 403. The protrusion portion 44 may be fixed to the first mounting portion 403 by bonding, thermal fusion, or the like.

In a direction perpendicular to the bottom surface 4b, the protrusion portion 44 may have a linear configuration, a curved configuration, an L-configuration, a U-configuration, or the like. The first opening 431 is located on one side or in the middle of the protrusion portion 44, and the protrusion portion 44 blocks one side of the first opening 431 or forms a semi-enclosed partition around the first opening 431. Both arrangements can prevent the user from inadvertently touching and blocking the first opening 431, thereby avoiding the howling.

In the embodiment, a height of the protrusion portion 44 is greater than 0.8 mm, a minimum distance between the protrusion portion 44 and an edge of the first opening 431 is less than 0.4 mm, to prevent the finger from blocking the first opening 431.

When the height of the protrusion portion 44 and the distance between the protrusion portion 44 and the first opening 431 are selected, the height of the protrusion portion 44 and the corresponding distance between the protrusion portion 44 and the first opening 431 need to be adjusted simultaneously. For example, when the height of the protrusion portion 44 is relatively short, the distance between the protrusion portion 44 and the first opening 431 needs to be further reduced to decrease the probability of the first opening 431 being blocked.

For example, when the height of the protrusion portion 44 is 0.8 mm, the minimum distance between the protrusion portion 44 and the edge of the first opening 431 is 0.2 mm. When the protrusion portion 44 is set lower, a smaller gap is required between the protrusion portion 44 and the first opening 431, so that the protrusion portion 44 performs the blocking function. When the height of the protrusion portion 44 is 1 mm, the minimum distance between the protrusion portion 44 and the edge of the first opening 431 may be 0.4 mm. When the protrusion portion 44 is set higher, the gap between the protrusion portion 44 and the first opening 431 may be set relatively wider, and the protrusion portion 44 may also perform the blocking function.

In other embodiments, the outer surface of the support member 4 is provided with the one or more button bosses 45. The first opening 431 is disposed beside one button boss 45. A portion of the button boss 45 close to the first opening 431 forms the protrusion portion 44. If the button boss 45 has a sufficient height and the distance between the button boss 45 and the first opening 431 is sufficiently small, the user’s finger is also be blocked to avoid the howling.

Referring to FIG. 17, in one embodiment, a hearing assistance device is provided. A difference between the hearing assistance device and the hearing assistance device in any of the above embodiments is that neither the recessed portion 42 nor the protrusion portion 44 is provided, and the first opening 431 and the button 41 are located at two ends of the same surface of the support member 4.

In the embodiment, the first opening 431 and the button 41 are located at two ends of the same surface of the support member 4, so that the distance between the first opening 431 and the button 41 is increased. When the user operates the button 41, even if an inadvertent touch occurs near the button 41, it is difficult to contact the first opening 431 farther from the button 41. The configuration can also significantly reduce the probability of the user inadvertently touching and blocking the first opening 431. That is, the probability of inadvertent touch causing the howling can be reduced.

In some embodiments, the first opening 431 and the button 41 are disposed at two ends of any surface of the support member 4, excluding the inner side surface that would be blocked by the user’s head. For example, the first opening 431 and the button 41 are disposed at two ends of the bottom surface 4b of the first mounting portion 403, the button 41 is located at a front end position of the bottom surface 4b, the first opening 431 is located at a rear end position of the bottom surface 4b, and the microphone hole 43 is located at a rear end position of the first mounting portion 403.

The first mounting portion 403 is an elongated structure. A length of the first mounting portion 403 in a front-rear direction is greater than a length of the first mounting portion 403 in other directions. The first opening 431 and the button 41 are located at the two ends of the bottom surface 4b of the first mounting portion 403 in the front-rear direction, and include a relatively large distance between the first opening 431 and the button 41, thereby providing good protection for the first opening 431, reducing the probability of the user inadvertently touching and blocking the first opening 431, and reducing the probability of inadvertent touch causing the howling.

The foregoing describes the present invention using specific examples, which are only intended to help understand the present invention and are not intended to limit the present invention. For those skilled in the art to which the present invention pertains, several simple deductions, modifications, or replacements can be made based on the concept of the present invention.

What is claimed is:

1. A hearing assistance device, comprising:
a microphone, configured to receive an initial sound signal and convert the initial sound signal into an electric signal;
a processor in signal connection with the microphone, wherein the processor is configured to process the electric signal and generate a control signal;
a speaker in signal connection with the processor, wherein the speaker is configured to convert the control signal into a hearing assistance sound signal; and
a support member worn on a user’s head, wherein
the microphone is disposed in the support member,
an outer surface of the support member is provided with a recessed portion,
the support member is further provided with a microphone hole,
the microphone hole has a first opening and a second opening opposite to each other, the first opening being located in the recessed portion, and the second opening being located on an inner surface of the support member and connected to the microphone, and
the recessed portion is configured to prevent the user from touching or blocking the first opening.

2. The hearing assistance device of claim 1, wherein the recessed portion has a bottom wall and a side wall, and the first opening is located on the bottom wall or the side wall of the recessed portion.

3. The hearing assistance device of claim 1, wherein the recessed portion is provided with a partition structure, the partition structure shields the first opening, and a gap is formed between the partition structure and the first opening.

4. The hearing assistance device of claim 3, wherein, in a direction perpendicular to the outer surface of the support member having the recessed portion, a projection of the partition structure covers all or part of the first opening.

5. The hearing assistance device of claim 3, wherein the partition structure is a partition plate or a partition mesh.

6. The hearing assistance device of claim 3, wherein an upper surface of the partition structure is flush with the outer surface of the support member having the recessed portion.

7. The hearing assistance device of claim 1, wherein the recessed portion is a strip-shaped groove.

8. The hearing assistance device of claim 7, wherein the first opening is located at a middle portion of the strip-shaped groove.

9. The hearing assistance device of claim 1, wherein the recessed portion has a linear configuration, a curved configuration, an X-configuration, or a herringbone configuration.

10. The hearing assistance device of claim 1, wherein
the outer surface of the support member is further provided with a button,
the outer surface of the support member includes a top surface, a bottom surface, an inner side surface, and an outer side surface,
the inner side surface faces the user when the hearing assistance device is worn by the user, and
the recessed portion and the button are disposed on the bottom surface.

11. The hearing assistance device of claim 10, wherein a portion of the recessed portion extends to at least one of the outer side surface or the inner side surface.

12. The hearing assistance device of claim 10, wherein a portion of the recessed portion extends to an edge of the bottom surface.

13. The hearing assistance device of claim 10, wherein at least a portion of an opening of the recessed portion faces a first direction, at least another portion of the opening of the recessed portion faces a second direction, and an included angle between the first direction and the second direction is greater than or equal to 60°.

14. The hearing assistance device of claim 10, wherein the outer surface of the support member is provided with a plurality of button bosses, the button is disposed on one of the button bosses, and a region between two adjacent button bosses forms the recessed portion.

15. The hearing assistance device of claim 10, wherein a distance between the first opening and the outer side surface is less than a distance between the first opening and the inner side surface.

16. The hearing assistance device of claim 1, wherein a width of the recessed portion is within a range of 1 millimeter (mm) to 2 mm, and a depth of the recessed portion is within a range of 0.5 mm to 1.5 mm.

17. The hearing assistance device of claim 16, wherein
the width of the recessed portion is within a range of 1.5 mm to 2 mm, and the depth of the recessed portion is within a range of 1 mm to 1.5 mm; or
the width of the recessed portion is within a range of 1.0 mm to 1.5 mm, and the depth of the recessed portion is within a range of 0.5 mm to 1 mm.

18. The hearing assistance device of claim 1, wherein a length of the recessed portion is larger than 5 mm.

19. A hearing assistance device, comprising:
a microphone, configured to receive an initial sound signal and convert the initial sound signal into an electric signal;
a processor in signal connection with the microphone, wherein the processor is configured to process the electric signal and generate a control signal;
a speaker in signal connection with the processor, wherein the speaker is configured to convert the control signal into a hearing assistance sound signal; and
a support member worn on a user’s head, wherein
the microphone is disposed in the support member,
an outer surface of the support member is provided with a protrusion portion,
the support member is further provided with a microphone hole,
the microphone hole has a first opening and a second opening opposite to each other, the first opening being located on the outer surface of the support member, and the second opening being located on an inner surface of the support member and connected to the microphone,
the protrusion portion is disposed on a side of the first opening, and
the protrusion portion is configured to prevent the user from touching or blocking the first opening.

20. A hearing assistance device, comprising:
a microphone, configured to receive an initial sound signal and convert the initial sound signal into an electric signal;
a processor in signal connection with the microphone, wherein the processor is configured to process the electric signal and generate a control signal;
a speaker in signal connection with the processor, wherein the speaker is configured to convert the control signal into a hearing assistance sound signal; and
a support member worn on a user’s head, wherein
the microphone is disposed in the support member,
an outer surface of the support member is provided with a button in signal connection with the processor;
the support member is further provided with a microphone hole,
the microphone hole has a first opening and a second opening opposite to each other, the first opening being located on the outer surface of the support member, and the second opening being located in the support member and connected to the microphone; and
the first opening and the button are located at two ends of a same surface of the support member.
